(19) United States
(12) Patent Application Publication
(10) Pub. No.: US 2010/0199629 A1
(43) Pub. Date: Aug. 12, 2010

(54) SYSTEME D'ANTI GIVRAGE ET DE DEGIVRAGE DE NACELLE DE MOTEUR D'AERONEF A TAPIS RESISTIF

(75) Inventors: Gilles Chene, Toulouse (FR); Alain Porte, Colomiers (FR); Jacques Lalane, Saint Orens (FR)

Correspondence Address: Perman & Green, LLP, 99 Hawley Lane, Stratford, CT, 06614, US

(73) Assignee: AIRBUS FRANCE, Toulouse Cedex 9 (FR)

(21) Appl. No.: 11/993,693

(22) PCT Filed: Jun. 19, 2006
(86) PCT No.: PCT/FR06/50608

§ 371 Date: Mar. 22, 2010

(30) Foreign Application Priority Data
Jun. 22, 2005 (FR) 05 51711
Jun. 22, 2005 (FR) 05 51712
Jun. 22, 2005 (FR) 05 51713

(51) Int. Cl. B64D 15/12; F02G 3/00

(52) U.S. Cl. 60/39.093

(57) ABSTRACT

A deicing and anti-icing system for an aircraft engine pod, including an air intake provided with a lip followed by an air intake tubular part, equipped with a first sound attenuating panel, including deicing means having at least one array of resistive heating elements embedded in an insulating material, the deicing means being in the form of a mat incorporating the resistive element in the thickness of the air intake lip.

### CROSS-REFERENCE TO RELATED APPLICATIONS

This application is National Stage of International Application No. PCT/FR2006/050608 filed 19 Jun. 2006, which claims priority to, and the benefit of, French Application Nos. 05 51712, filed on 22 Jun. 2005, 05 51711, filed 22 Jun. 2005 and 05 51713 filed 22 Jun. 2005, the disclosures of which are incorporated herein by reference in their entireties.

### BACKGROUND

The disclosed embodiments relate to an anti-icing and deicing system for an aircraft engine pod, using a resistive mat.

The disclosed embodiments also relate to an aircraft engine pod with an improved deicing device and optimized acoustic attenuation based on a resistive mat.

Finally, the disclosed embodiments relate to a deicing system with arrays of resistive elements consisting of segregated resistive mats which is particularly applicable to the deicing of aircraft engine pods.

It is known practice to produce aircraft pods, the internal passage of which surrounds a fan, comprising a tubular air intake provided with a lip and a fan casing provided with a first internal tubular acoustic attenuation piece in which a tubular transition part connects the air intake to the fan casing.

The air intake and the lip have traditionally been deiced by conveying hot air from the jet engine along pipes or passages positioned in the thickness of the pod to the air intake.

One technical problem stems from the fact that the hot air carried is, under certain flight conditions, at a very high temperature (up to 600° C.) and from the fact that the tubular acoustic attenuation piece or pieces made of composite are incompatible with such temperatures.

Deicing is particularly necessary when the airplane is in a descent phase and particularly during the long final descents during which the engines are running at idling speeds for prolonged periods. In such cases, the temperature of the air in the hot air ducts is low and a high air flow is needed.

This implies that, conversely, when the outside temperature is high and the engine is providing thrust, if the deicing airflow regulating valve is open, the air reaches the aforementioned high temperatures. This is especially the case when the valve is locked in the open position to allow flight to proceed if the valve control system has failed.

Reducing the air temperature in the phases during which excessive heat is to be avoided is a very complicated matter because, in the prior art, the hot air deicing systems need to be engineered to allow the engine to be deiced during the phases at which it is running at idling speeds and to produce a device capable of cooling the air under special circumstances would entail complicated equipment (a heat exchanger, valve, regulator and other components) which would prove bulky and heavy.

Hence, in the prior art, it has been found preferable to keep the heat-sensitive acoustic attenuation part away from the part that is deiced and in order to do this, the tubular transition part comprises a junction region where the air intake and the fan casing meet, which region has no deicing means in order to keep the tubular part equipped with the acoustic attenuation means away from the part which is heated.

This construction presents two problems in particular: the first is that an annular section of the air intake has no acoustic attenuation material, thus reducing the effectiveness of these noise-reduction means, and the second of which is that this same annular section has no deicing means and therefore remains potentially exposed to the build-up of ice.

### SUMMARY

The deicing system of the disclosed embodiments are intended to allow the acoustic attenuation regions and the regions that are deiced to be brought closer together and even overlapped, and also affords a reduction in engine pressure drops given that, for a civilian aircraft engine of the customary power, the hot air anti-icing system of the prior art taps of the order of 60 to 80 kW of power off the engine without any true regulating or limiting means.

The deicing device of the disclosed embodiments are also intended to appreciably reduce, if not even to eliminate, the annular transition section and bring the part that is deiced and the part that is provided with the acoustic attenuation means closer together, or even overlap them, so as to increase both the area that is deiced and the area that is equipped with acoustic attenuation means.

In addition, the deicing device according to the disclosed embodiments which are laid out on the surface does not require any complex pipe and valve systems.

Furthermore, the pneumatic system of the prior art is able to perform the anti-icing function but not the deicing function in a simple and readily implementable way, whereas the system of the disclosed embodiments allows specific regions to be deiced by temporarily delivering to them the power needed for this deicing function, the power drawn being tailored to suit the anti-icing and deicing modes chosen.

The disclosed embodiments propose to produce a deicing and anti-icing system that does not occupy any space inside the pod, does not consume very much power, and offers great flexibility as to use by adapting the deicing powers to suit the flight conditions and the conditions on the ground.

In this context, the disclosed embodiments provide a system for deicing and preventing icing of an aircraft engine pod, comprising an air intake provided with a lip followed by a tubular air intake piece equipped with a first acoustic attenuation panel, characterized in that it comprises deicing means consisting of at least one array of resistive heating elements embedded in an electrically insulating material, the deicing means being in the form of a mat incorporating the resistive elements within the thickness of the air intake lip.

According to one particular embodiment, the disclosed embodiments provide an aircraft engine pod comprising an air intake provided with a lip followed by a tubular air intake piece equipped with a first acoustic attenuation panel, characterized in that the lip is equipped with a deicing system provided with a deicing device which comprises deicing means consisting of at least one array of resistive heating elements embedded in an electrically insulating material, the deicing means being in the form of a mat incorporating the resistive elements within the thickness of the air intake lip, the array forming part of the wall of the lip, covering part of the lip, internal to the air intake, and extending, on the one hand, over at least part of the lip external to the air intake and, on the other hand, over at least one junction region where the lip and the first acoustic attenuation panel of the tubular air intake piece meet.

More specifically, the air intake is divided into a succession of deicing sectors which form a succession of subarrays controlled by at least one control circuit designed either to heat the sectors in sequence or to deliver power to certain sectors simultaneously.

According to one aspect of the preferred embodiments, the deicing system comprises deicing means consisting of at least two arrays of resistive heating elements embedded in an insulating material, at least two series of resistive elements of said arrays being segregated in such a way as to form two segregated arrays incorporated into the thickness of a panel that is to be deiced.

The deicing system according to the disclosed embodiments advantageously comprises array control circuits comprising two independent channels for controlling the supply of electrical power to the two resistive arrays.

The disclosed embodiments also relate to a method of controlling a deicing and anti-icing system for an aircraft engine pod air intake, characterized in that the air intake is divided into a succession of deicing sectors, a succession of resistive arrays positioned in the deicing sectors are controlled by at least one control circuit designed to deliver power to said sectors simultaneously or in sequence.

Aside from the improvement in operational flexibility afforded by the system according to the disclosed embodiments, a system such as this is particularly well suited to increasing the acoustic insulation of the air intake made of composite, because a system such as this does not subject its environment to high temperatures even when running in downgraded mode.

### BRIEF DESCRIPTION OF THE DRAWINGS

Other features and advantages of the disclosed embodiments will be better understood from reading the description which will follow of one nonlimiting exemplary aspect of the disclosed embodiments given with reference to the drawings which depict:

FIG. 1: an overall view of an aircraft engine pod in part section;

FIG. 2: a schematic section view of a front part of a pod according to the prior art;

FIG. 3: a schematic section view of a front part of a pod according to a first exemplary embodiment;

FIG. 4: a schematic section view of a front part of a pod according to a first alternative form of embodiment;

FIG. 5: a schematic section view of a front part of a pod according to a second alternative form of embodiment;

FIG. 6: a schematic section view of a front part of a pod according to a third alternative form of embodiment;

FIG. 7A: a section view of a resistive array according to one aspect of the disclosed embodiments;

FIG. 7B: a detail of an array of FIG. 7A;

FIGS. 8A, 8B and 8C: schematic views of air intake sectors equipped with a deicing system according to the disclosed embodiments;

FIGS. 9A and 9B: a schematic depiction of two methods of operation of a deicing system according to the disclosed embodiments;

FIG. 10: two exemplary embodiments of deicing systems according to the disclosed embodiments;

FIGS. 11A and 11B: two examples of operating cycles of a deicing system according to the disclosed embodiments.

### DETAILED DESCRIPTION OF THE DISCLOSED EMBODIMENTS

The disclosed embodiments are concerned chiefly with the deicing and prevention of icing of parts of aircraft and, in particular, of the engine pods of these aircraft.

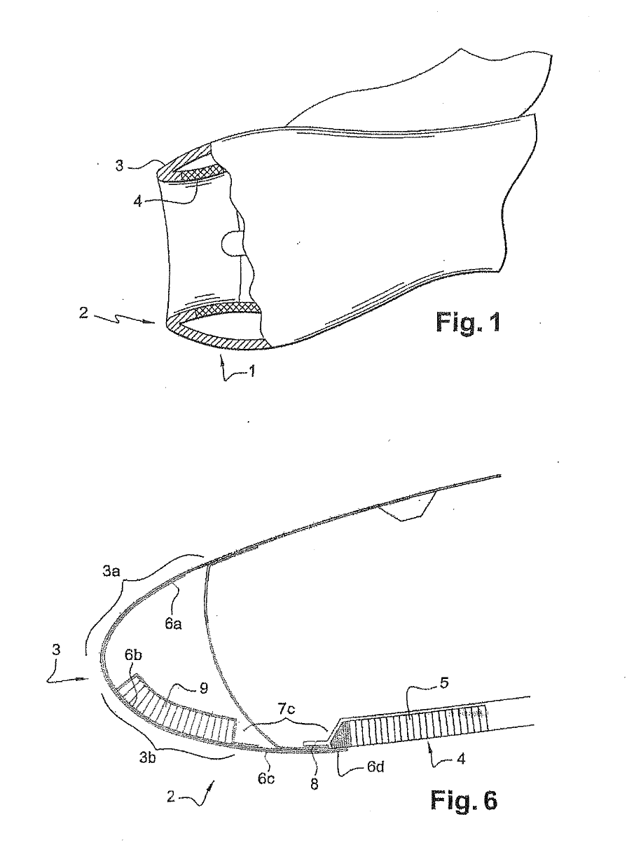

An aircraft engine pod 1 is depicted schematically in general in FIG. 1.

A pod 1 such as this comprises an air intake 2 provided with a lip 3 followed by a tubular air intake piece 4.

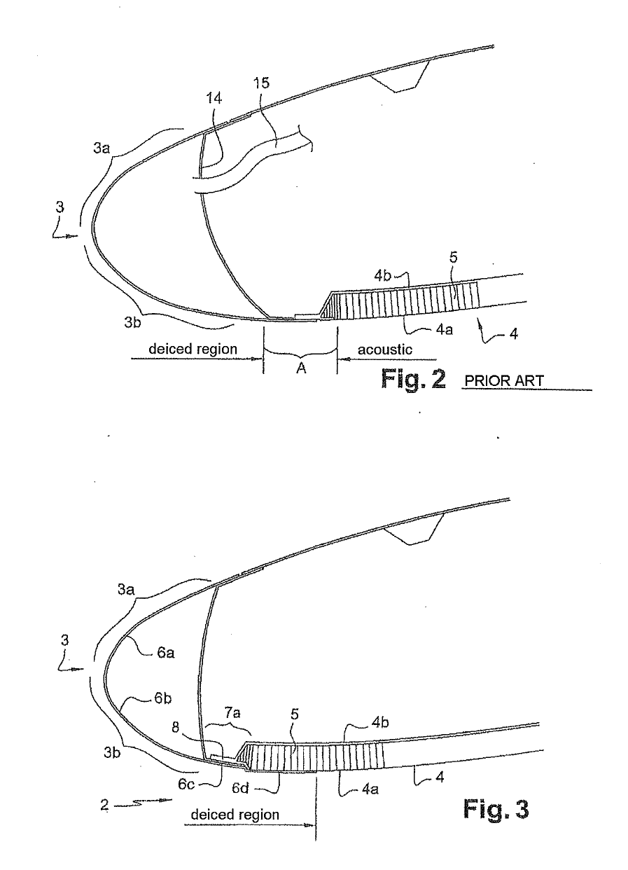

The front part of such a pod according to the prior art is depicted in FIG. 2 which shows that the tubular part 4 comprising an acoustic attenuation panel is set back from the air intake lip 3 to leave a buffer region A between the deiced part situated forward of an internal bulkhead 14 and the part provided with the acoustic attenuation panel 5 so as to protect this panel from the high temperatures of the hot air deicing device symbolized by a pipe 15.

According to the exemplary embodiments shown in FIGS. 3, 4 and 5, the pod still comprises a tubular piece equipped with a first acoustic attenuation panel 5 made of composite and, according to the disclosed embodiments, the lip is equipped with deicing means 6, 6a, 6b, 6c, 6d that form part of the wall of the lip and replace the hot air deicing means.

The deicing means according to the disclosed embodiments cover part 3b of the lip, internal to the air intake, and extend, on the one hand, over part 3a of the lip external to the air intake and, on the other hand, over a junction region 7a, 7b, 7c where the lip and the tubular air intake piece meet.

More specifically and particularly according to the exemplary embodiment of FIG. 3, the junction region 7a comprises a projection 8 of the tubular air intake piece secured to an internal edge of a continuation of the lip 3, the deicing means 6c covering said projection 8.

The composite tubular piece 4 comprises an outer skin 4a and an inner skin 4b sandwiching an acoustic attenuation material to form said first acoustic attenuation panel 5 and the projection 8 consists of a pinched-together edge of the outer and inner skins 4a, 4b, these pinched-together edges being joined together by bonding or curing under the action of heat the resin with which the skins 4a, 4b are impregnated, as is known in the methods for producing composite acoustic panels, for example described in document EP 0 897 174 A1.

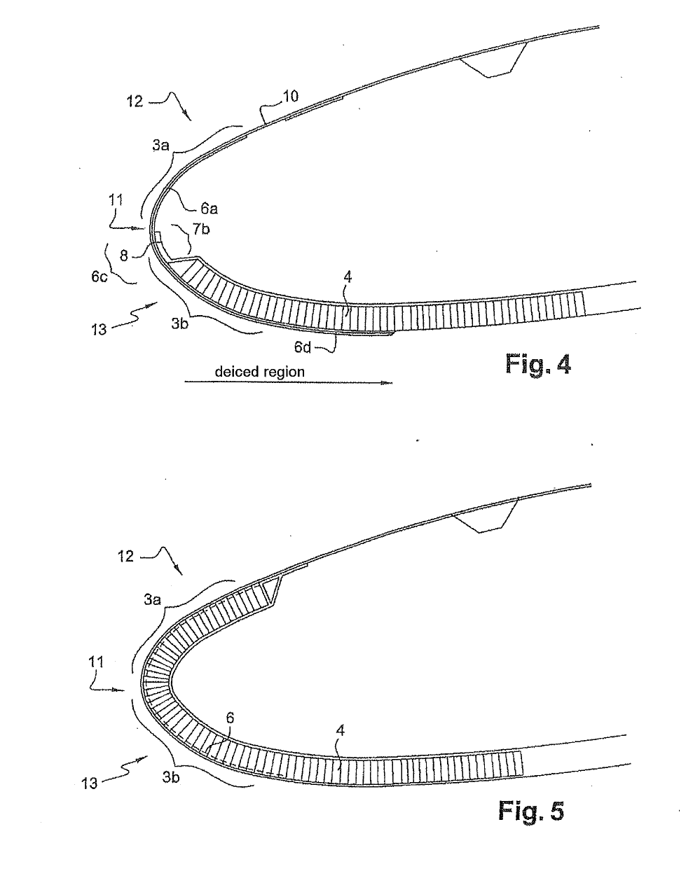

According to the example of FIG. 4, the lip 3 consists of an upper cowl 10 that forms the suction face 12 of the air intake and continues beyond the leading edge 11 of the lip, the tubular air intake piece 4 equipped with the first acoustic attenuation panel being extended to form part of the pressure face 13 of the lip 3. According to this example, the deicing means that form part of the wall of the lip comprise a first mat 6a laid down on the internal wall of the upper cowl 10 and a second mat laid down on the external face of the acoustic attenuation panel 5 of the continued air intake piece, the junction region 7b lying approximately in the region of the leading edge 11 of the lip 3.

A construction such as this has the advantage of producing an acoustic attenuation region that is continuous from the inside of the engine as far as the leading edge of the lip, and this is particularly of advantage in combating noise.

According to the example of FIG. 5, the lip 3 consists entirely of a continuation of the tubular air intake piece which forms the pressure face 13, the leading edge 11 and the suction face 12 of the lip 3.

According to the example of FIG. 6, whereby the original air intake structure of FIG. 2 is preserved, the deicing means 6d extend beyond the junction region to cover at least part of the tubular air intake piece.

The deicing means 6a cover the external region 3a of the lip, the means 6b cover the internal region 3b of the lip which in this instance has a first acoustic region 9, the means 6c cover a junction region 7c where the lip and the air intake meet, and the means 6d cover part of a second acoustic region 5.

The deicing means 6, 6a, 6b, 6c, 6d depicted are electrical means and in particular consist of a mat incorporating heating resistors.

To protect this mat, it is preferable to position it on the internal surface of the lip at least in the exposed tip or leading edge part of the lip. When the deicing means have to cover an acoustic panel, the mat may, on the other hand, be positioned on the external surface of the panel and be pierced with holes to allow the acoustic attenuation panel to work by leaving a proportion of open surfaces compatible with the desired acoustic attenuation.

The disclosed embodiments are particularly applicable to aircraft pods that comprise parts made of composite and particularly pods in which the tubular air intake piece 4 and the acoustic attenuation panels 5, 9 are made of composite.

When electrical deicing means are produced, the device is designed to operate as an anti-icing device preventing ice from forming on those surfaces that are to be protected or as a deicing device so that it can remove a deposit of ice that has built up on the surface.

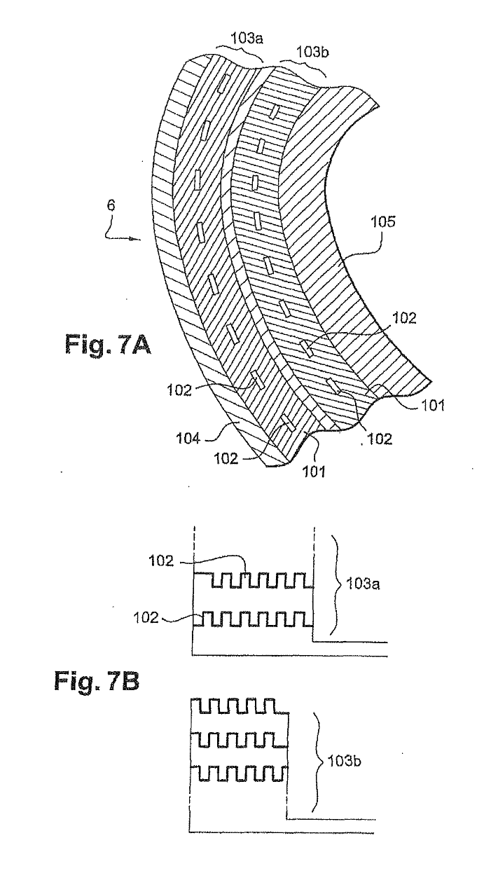

A device and system such as this and the way in which they operate are described in FIGS. 7A to 11B.

As explained above, and particularly in the case of engines of the turbofan type, an earlier technique employed in deicing systems was to tap pneumatic power off the engine to route hot air through pipework to the regions that are to be deiced.

A technique such as this relies on there being enough pneumatic power that can be taken from the engine propulsion power, on there being control valve devices and electrical control systems for operating these valves and on there being enough space to lead the pipework into the pods.

By comparison with this complex prior art, the system comprises electrical heating elements embedded in the thickness of the panels that form the air intake lip 3 and the tubular air intake piece to produce a system for deicing the pod 1 of an aircraft engine comprising an air intake 2 provided with a lip 3.

As depicted in FIG. 7A, the electrical heating elements which constitute the deicing means 6, 6a, 6b, 6c, 6d consist of at least one array of resistive heating elements 102 embedded in an insulating material 101, the deicing means being in the form of a mat 103a, 103b incorporating the resistive elements 102 within the thickness of the air intake lip between the panels 104, 105 of which it is formed.

The arrays of resistive elements 102 comprise heating electrical resistors that dissipate electrical power through the Joule effect and which are embedded in the insulating material 101.

The deicing means are either metal resistive elements, for example made of copper, or composite resistive elements, for example elements made of carbon.

The electrical insulator covering the resistive elements is a flexible material particularly of the silicone or neoprene type.

As depicted in FIG. 7B, the resistive elements 102 are connected in parallel as this limits the risk of loss of effectiveness of the system should one element break, for example as the result of an impact between a foreign object and the air intake.

Each resistive element 102 is spaced away from the adjacent elements by enough of a distance to ensure appropriate electrical insulation (typically of the order of 2 mm for the customary supply voltages of 0 to 400 V DC or AC).

Furthermore, as depicted in FIG. 7A, the array of resistive element heaters 102 is duplicated in such a way as to produce two segregated arrays 103a, 103b incorporated within the thickness of the lip.

This duplication of the arrays is performed in such a way that should one of the arrays fail, the ice protection function will be afforded in a downgraded mode by the other of the arrays.

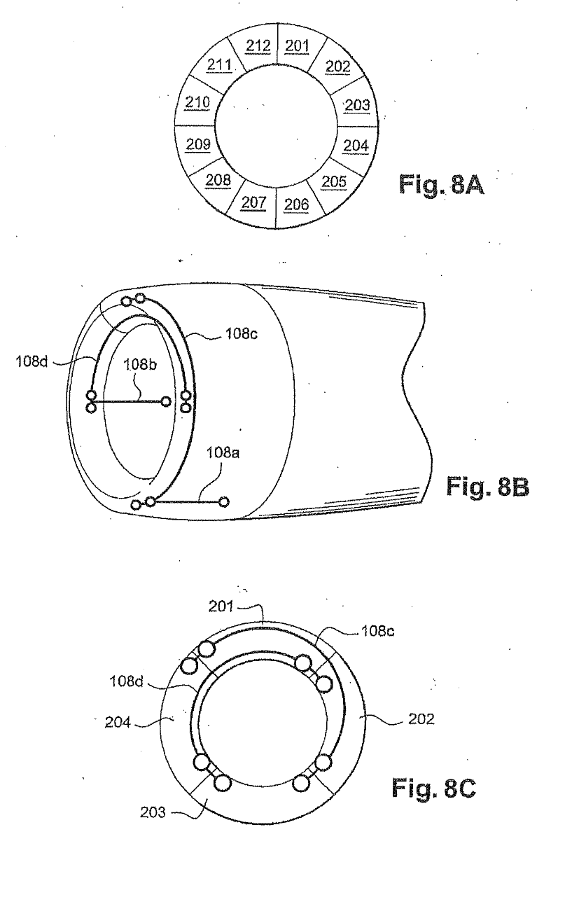

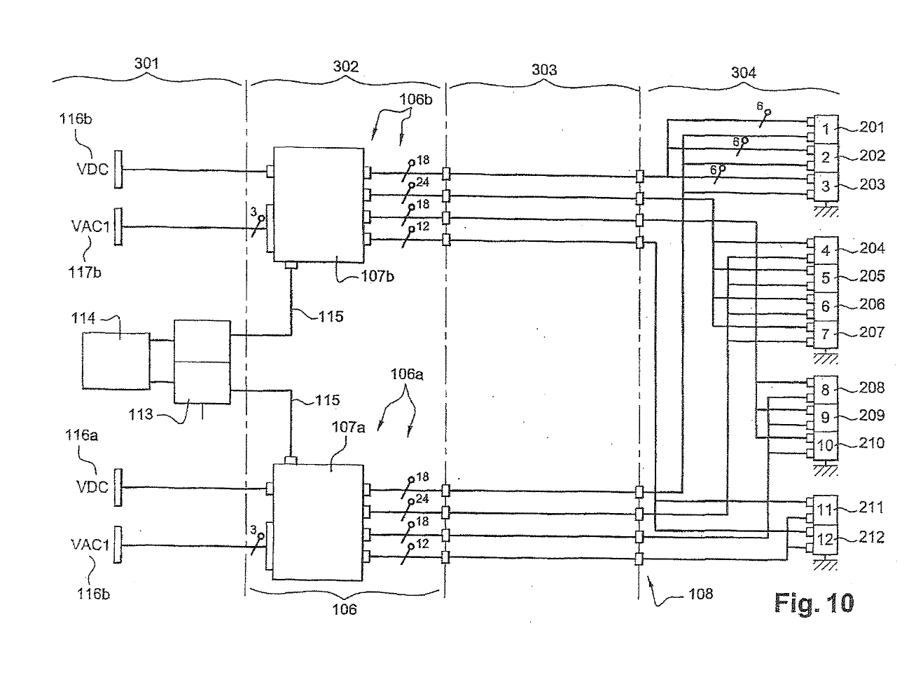

To control these arrays, the system depicted comprises array control circuits 106, 106a, 106b comprising two independent channels which independently control the delivery of electrical power to the two resistive arrays 103a, 103b. A schematic depiction of these control circuits is given in FIG. 10 whereas an example of the routing of the power supply wiring 108a, 108b, 108c, 108d which avoids running wiring in the most exposed lower region of the air intake is given in FIGS. 8B and 8C in the context of subdivision of the air intake into four sectors that form four subarrays 201, 202, 203, 204.

Indeed, again with a mind to safety, and also to optimize the electrical power consumption of the system, the disclosed embodiments envision dividing the air intake into a succession of deicing sectors, 121 according to FIG. 8A, which form a succession of subarrays 201, . . . , 212 controlled separately by at least one control circuit 106, 106a, 106b designed either to heat the sectors in sequence or to deliver power to certain sectors simultaneously.

The wiring 108a, 108b, 108c, 108d groups together the current inputs and outputs for the sectors it covers.

FIG. 8A depicts four sections, the section 301 corresponding to the connection with the cockpit, the section 302 being the section in the engine pylori combining the system cycling or sequencing control units 107a and 107b, the section 303 comprising the routing of wiring between the pylori and the air intake and the section 304 corresponding to the air intake.

The power that has to be dissipated in order for the anti-icing system to work correctly depends on the position of the heating element within the air intake, the most critical region of the profile being the internal part of the air intake starting from the leading edge of the lip.

In order to prevent icing in a region such as this, the power to be dissipated is a power of the order of 1.5 W/cm² applied continuously.

For the less critical regions, operation in deicing mode based on a cycle of periodic heating of the surfaces will make it possible to limit the power consumption of the system even though the instantaneous power dissipated is greater being of the order of 2 to 3 W/cm².

In operation such as this in deicing mode, the control circuit or circuits are designed to deliver and cut off power to the arrays 103a, 103b or subarrays 201, 212 according to defined time cycles 109 depicted in FIGS. 11A and 11B.

The time cycle depicted in FIG. 11A comprises a passing of current through the resistive element for a duration T0 to T3 leading to a temperature rise phase P1, an ice-melting phase P2 at 0° C., an overheating temperature rise phase P3. The circuit is then switched off, this corresponding to a cooling phase P4.

FIG. 11B represents the cycles for all the sectors, the phases of electrical conduction for heating the resistive elements being performed in succession.

Operation in this deicing mode will, in respect of the air intake regions, make it possible to mitigate against deficiency of one of the circuits while at the same time maintaining sufficient deicing capability.

The system control circuit depicted in FIG. 10 in the context of two separate circuits 106a, 106b comprises a series of cable bundles 108 delivering power to all of the resistive subarrays.

These bundles constitute independent channels connected to the units 107a, 107b which are separated or connected to a single control unit itself connected by a bus 115 to a unit 113 that provides monitoring and communication with the instrument panel 114 to display system control and operating parameters.

As seen earlier, the supply of power to the heating arrays of a pod is performed using two independent sets of power supply wiring 108, 108a, 108b, 108c and dedicated sets of electrical connectors.

The wiring in each set is installed in such a way as to be completely separate from that of the other set, so as to minimize the risks of common failures in the circuits.

The system described optimizes the power consumption because the control circuits are designed to deliver and cut off power to the heaters in accordance with time cycles that are defined according to the phase of flight or conditions of use of the system.

The unit or units 107a, 107b monitor the sets of wiring and of resistive-array heaters, make sure that the electrical voltages and currents supplied are appropriate and monitor the system by measuring the absence of unintended short circuits or unintended open circuits.

Likewise, the unit power supply circuits, which for example supply power through busbars connected to DC voltage sources 116a, 116b and AC voltage sources 117a, 117b, are independent. Furthermore, to increase the level of redundancy, each unit is powered by two independent busbars.

At any given moment, each channel or unit uses the same electrical busbar so that, if there is a problem with electrical insulation between the two arrays of heaters, only one of the busbars will be affected.

In particular, in the event of loss of one of the busbars on one of the units or channels, the two units or channels will use the other busbar.

To control the system according to the disclosed embodiments, the air intake is divided into a succession of deicing sectors and a succession of resistive arrays 201, . . . , 212 positioned in the deicing sectors are controlled by at least one control circuit 106, 106a, 106b designed to deliver power to said sectors simultaneously or in sequence.

Deicing or anti-icing operation may be preferred according to the location of the subarrays.

An anti-icing phase 110 is carried out by operating at least one deicing sector continuously, whereas a deicing phase 111 is carried out by means of a cycle involving periodic heating of at least one sector.

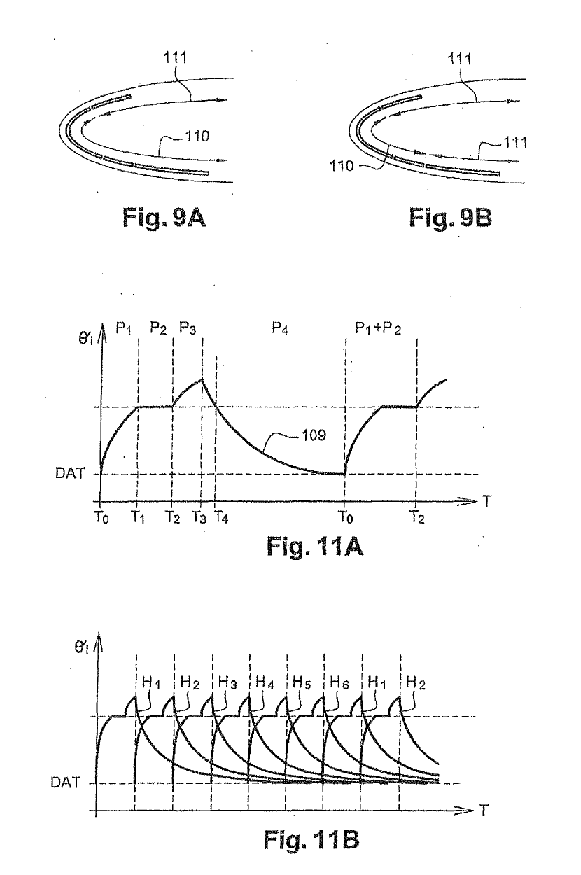

FIG. 9A depicts a method of operation whereby the external part of the pod is deiced with sequential application of power to the sectors and the tip of the air intake lip and the tubular air intake part are operated in anti-icing mode by continuously delivering power to the resistive arrays positioned in this part.

FIG. 9B depicts a method of operation whereby the external part of the pod and the tubular air intake part are powered in deicing sequences, only the tip of the air intake lip being powered in anti-icing mode.

The disclosed embodiments are not restricted to the exemplary embodiments depicted and, in particular, the methods of operation can be altered to favor anti-icing operation or deicing operation according to the flight conditions, the status of the system or the power available, it being possible for the segregated arrays to be separated laterally to cover consecutive regions as in FIG. 7B, spaced apart regions, or be positioned in stacks or comprise combinations of these layouts.

1. A system for deicing and preventing icing of an aircraft engine pod, comprising:
an air intake provided with a lip followed by a tubular air intake piece equipped with a first acoustic attenuation panel,
deicing means comprising at least one array of resistive heating elements embedded in an electrically insulating material, the deicing means being in the form of a mat incorporating the resistive elements within the thickness of the air intake lip.

2. The deicing system as claimed in claim 1, wherein each resistive element is spaced away from the adjacent elements by enough of a distance to ensure electrical insulation between the elements.

3. The deicing system as claimed in claim 1, wherein the electrically insulating material covering the resistive elements is a flexible material particularly of the silicone or neoprene type.

4. An aircraft engine pod comprising an air intake provided with a lip followed by a tubular air intake piece equipped with a first acoustic attenuation panel, wherein the lip is equipped with a deicing system as claimed in claim 1, forming part of the wall of the lip, covering part of the lip, internal to the air intake, and extending, on the one hand, over at least part of the lip external to the air intake and, on the other hand, over at least one junction region where the lip and the first acoustic attenuation panel of the tubular air intake piece meet.

5. The aircraft engine pod as claimed in claim 4, wherein the junction region comprises a projection of the tubular air intake piece secured to an internal edge of a continuation of the lip, the deicing means covering said projection.

6. The aircraft engine pod as claimed in claim 4, wherein the tubular piece is made of composite and comprises an outer skin and an inner skin sandwiching an acoustic attenuation material to form said first acoustic attenuation panel, the projection consisting of a pinched-together edge of the outer and inner skins.

7. The aircraft engine pod as claimed in claim 4, wherein a second acoustic attenuation panel is positioned on the part of the lip internal to the air intake.

8. The aircraft engine pod as claimed in claim 4, wherein the lip comprises an upper cowl that forms the suction face of the air intake and continues beyond the leading edge of the lip, the tubular air intake piece equipped with the first acoustic attenuation panel being extended to form part of the pressure face of the lip.

9. The aircraft engine pod as claimed in claim 4, wherein the lip comprises a continuation of the tubular air intake piece which continues to form the pressure face, the leading edge and the suction face of the lip.

10. The aircraft engine pod as claimed in claim 4, wherein the deicing means extend beyond the junction region to cover at least part of the first acoustic attenuation panel of the tubular air intake piece and are pierced with holes to allow the acoustic attenuation panel to work by leaving a proportion of open surfaces compatible with the desired acoustic attenuation.

11. The aircraft engine pod as claimed in claim 4, wherein the tubular air intake piece and the acoustic attenuation panels are made of composite.

12. A deicing system for an aircraft pod comprising an air intake provided with a lip followed by a tubular air intake piece equipped with a first acoustic attenuation panel,
the deicing means comprising at least one array of resistive heating elements embedded in an electrically insulating material, the deicing means being in the form of a mat incorporating the resistive elements within the thickness of the air intake lip and forming part of the wall of the lip, covering part of the lip, internal to the air intake, and extending, on the one hand, over at least part of the lip external to the air intake and, on the other hand, over at least one junction region where the lip and the first acoustic attenuation panel of the tubular air intake piece meet,
wherein the air intake is divided into a succession of deicing sectors which form a succession of subarrays controlled by at least one control circuit designed either to heat the sectors in sequence or to deliver power to certain sectors simultaneously.

13. The deicing system as claimed in claim 12, wherein the control circuit is designed to deliver and cut off power to the arrays or subarrays according to defined time cycles.

14. The deicing system as claimed in claim 13, wherein the system comprises two independent control circuits.

15. The deicing system as claimed in claim 14, wherein the control circuits are combined into a single control unit.

16. The deicing system as claimed in claim 12, wherein the control circuit or circuits comprise control units designed to monitor the resistive arrays and the wiring delivering power to them and comprise means for measuring the electrical voltages and currents supplied and for measuring the absence of unintended short circuits or unintended open circuits.

17. A deicing system for an aircraft pod comprising an air intake provided with a lip followed by a tubular air intake piece equipped with a first acoustic attenuation panel,
the deicing means (6, 6a, 6b, 6c, 6d) comprising at least two arrays of resistive heating elements (102) embedded in an insulating material (101), at least two series of resistive elements of said arrays being segregated in such a way as to form two segregated arrays (103a, 103b) incorporated into the thickness of a panel that is to be deiced.

18. The deicing system as claimed in claim 17, wherein each resistive element is spaced away from the adjacent elements by enough of a distance to ensure electrical insulation between the elements.

19. The deicing system as claimed in claim 17, wherein at least some of the resistive elements of a segregated array are connected in parallel.

20. The deicing system as claimed in claim 19, wherein the system comprises array control circuits comprising two independent channels for controlling the supply of electrical power to the two resistive arrays.

21. The deicing system as claimed in claim 20, wherein independent channels are combined into a single control unit.

22. The deicing system as claimed in claim 17, wherein the system is produced in an aircraft engine pod comprising an air intake equipped with a lip followed by a tubular air intake piece, the air intake is divided into a succession of deicing sectors which form a succession of subarrays controlled by at least one control circuit designed either to heat the sectors in sequence or to deliver power to certain sectors simultaneously.

23. The deicing system as claimed in claim 22, wherein the control circuits are designed to deliver and cut off power to the arrays or subarrays independently.

24. The deicing system as claimed in claim 17, wherein the control circuit or circuits comprise control units designed to monitor the resistive arrays and the wiring delivering power to them and comprise means for measuring the electrical voltages and currents supplied and for measuring the absence of unintended short circuits or unintended open circuits.

25. A method of controlling a deicing and anti-icing system for an aircraft engine pod air intake as claimed in claim 4, wherein the air intake is divided into a succession of deicing sectors, a succession of resistive arrays positioned in the deicing sectors are controlled by at least one control circuit designed to deliver power to said sectors simultaneously or in sequence.

26. The method of controlling a deicing and anti-icing system as claimed in claim 25, wherein an anti-icing phase is carried out by operating at least one deicing sector continuously.

27. The method of controlling a deicing and anti-icing system as claimed in claim 26, wherein a deicing phase is carried out by means of a cycle involving periodic heating of at least one sector.
